(19) United States
(12) Patent Application Publication
(10) Pub. No.: US 2003/0098910 A1
(43) Pub. Date: May 29, 2003

(54) Apparatus and method of providing point-of-sale surveillance and auditing of sale transactions of goods

(76) Inventor: Pilsoo Kim, Newport Beach, CA (US)

Correspondence Address: David E. Allred, MYERS, DAWES & ANDRAS LLP, Suite 1150, 19900 MacArthur Boulevard, Irvine, CA, 92612, US

(21) Appl. No.: 09/997,561

(22) Filed: Nov. 29, 2001

(51) Int. Cl. H04N 7/18; G06F 17/60

(52) U.S. Cl. 348/150; 705/16; 348/159

(57) ABSTRACT

A point of sale (POS) surveillance system has the ability to show side-by-side pictures of the cash register readout and a visual record of the physical transaction, including the items purchased. Through picture-in-picture (PIP) technology, not only side-by-side register readout and visual record are available, but several side-by-side pairs of such pictures can be displayed on a single screen showing several points of sale simultaneously. Other embodiments include plural visual records per transaction, several cameras per POS, and kits for installing the surveillance system. A method of using the surveillance system is also disclosed. Each embodiment provides a permanent record. It is also contemplated that each embodiment would include a system for keeping track of inventory corrected by any discrepancies found in the transactions.

### BACKGROUND OF THE INVENTION

1. Field of the Invention

The invention relates to the field of computerized point-of-sale apparatus, and in particular computerized point-of-sale apparatus which are directed to providing for a means to audit the transaction at the point of sale.

2. Description of the Prior Art

Owners of retail stores report that more than 75% of the suspected theft in apparel and general merchandise stores occurs at the hands of their own employees. Perhaps this is due to crackdowns on shoplifting and other traditional methods of theft. Indeed, the advent of sensory devices and the attachment of actuators to apparel and other merchandise have made shoplifting more difficult. In any case, it appears that cashiers are colluding with others to enact partial purchases in which some of the merchandise is removed from stores without payment.

Unfortunately, the owners are now forced to suspect their own employees as thieves. While these employees may be watched and inventory can be compared to cash register readouts, a more comprehensive method that supplies sound evidence is needed.

The invention bridges two distinct areas of art. One is the area of automatic inventory devices, which include recording of transaction records for review of transactions at any of various points of sale (POS). These records are in the form of cash register readouts. Inventory for a store utilizing these devices is automatically kept by subtracting the items sold from the inventory record.

The other area of art includes picture in picture (PIP) technology, which is in wide use in surveillance. This technology is utilized to view visual records of a variety of locations on a single screen.

At present the prior art fails to combine the useful aspects of these two areas in a single system to discover or discourage collusion and pilfering by employees.

### BRIEF SUMMARY OF THE INVENTION

The instant invention is thus directed at solving the above stated problems by a point of sale (POS) surveillance system that has the ability to show side-by-side pictures of the cash register readout and a visual record of the physical transaction, including the items purchased. The invention employs picture in picture (PIP) technology for side-by-side register readout and visual record pictures, and for a plurality of side-by-side pairs of such pictures that can be displayed on a single screen. This permits a security officer to view several points of sale simultaneously.

Other embodiments include plural visual records per transaction, several cameras per POS, and kits for installing the POS surveillance system in new or existing register/inventory systems.

In all embodiments a permanent record is made in which the cash register readout and the corresponding visual record(s) are correlated for adjacent screen viewing and reviewing.

A method of using the surveillance system involves placing a camera to capture the needed visual records of the transactions and items sold, viewing the visual record and the cash register readout, and comparing the visual record with the cash register readout to determine discrepancies.

It is also contemplated that each of the embodiments would include a means for keeping track of inventory as is known in the art.

More particularly the invention is a point of sale (POS) surveillance system for comparing a cash register readout with a visual record of items purchased comprising a cash register which produces an electronic report of a sales transaction, a camera which makes a visual image of goods which are subject to the sales transaction, and a processor coupled to the camera and cash register, which processor creates a record in which the visual image of goods and electronic report are correlated with each other.

The POS surveillance system may further comprise at least one digital recorder for storing the record of the correlated visual image of goods and electronic report. The digital recorder stores a multiplicity of correlated visual images of goods and electronic reports corresponding to a corresponding multiplicity of sales transactions.

In one embodiment the report from the cash register is in a video graphics array (VGA) format and the invention further comprises a conversion device to convert the electronic report to a television compatible format. It is to be clearly understood that the invention is not limited by the data format that is output from the cash register or from the camera. Any formats and conversions between them can be employed without departing from the spirit and scope of the invention.

The POS surveillance system further comprises a multi-picture display device in which the correlated visual image of goods and electronic report are displayed. In the illustrated embodiment the multi-picture display device comprises a picture in picture (PIP) output displaying the electronic report adjacent to the visual image.

It must be further understood that a plurality of cameras corresponding to a plurality of points of sale each with its own cash register can be combined into a single system. In such an embodiment the processor simultaneously displays electronic reports from the plurality of cash registers and corresponding visual images of goods from the plurality of cameras, so that a security agent at a remote location may simultaneously view in real time a corresponding plurality of sales transactions with corresponding visual records from a plurality of distinct points of sale. The POS surveillance system may further comprise means for creating a permanent record of the electronic report and the corresponding visual image of the goods correlated to the sales transaction.

In another embodiment the POS surveillance system may further comprise an automatic inventory record system for keeping track of merchandise remaining in stock with the option of correcting the inventory for lost stock or discrepancies in sales as detected with use of the system.

The invention includes not only the integrated system as described above, but a point of sale (POS) surveillance system kit for use with a pre-existing computer and a cash register with VGA readout. For example, the kit comprises a camera with visual readout, a VGA-to-TV conversion device, a cable for cash register readout adapted for connection to the conversion device, a cable for camera output adapted for connection to the computer, a cable for output of the conversion device and adapted for connection to the computer, and software for integrating the surveillance system with DVR (Digital Video Recording) software and the computer. The computer is arranged and configured under software control to create a permanent record of the cash register readout and a corresponding visual record for easy recall, the DVR software also comprises picture in picture (PIP) capability and programming for processing the cash register and camera visual readout and for graphically displaying correlated images of the cash register readout and camera visual readout.

The kit can also be provided for a plurality of points of sale (POS), a corresponding plurality of cash registers with readout for use with a computer. In this embodiment the kit comprises (a) at least one camera per POS with a camera output, (b) at least one VGA-to-TV conversion device per POS, (c) a cable for each cash register readout to a respective the conversion device, (d) a cable for each camera output adapted for connection to the computer, (e) a cable for each output of a respective conversion device and adapted for connection to the computer, and (f) software for integrating the srveillance system with DVR software and the computer. The computer is arranged and configured by software control to create a permanent record of each cash register readout and a corresponding visual record of goods which were sold at the POS corresponding to the cash register readout, the DVR software further providing picture in picture (PIP) capability and programming for processing cash register readout and camera output from each POS and for displaying the cash register readout and camera output in a correlated visual format on a screen.

The invention is also defined as a method for providing point of sale (POS) surveillance comprising: (a) receiving and storing data from a cash register transaction readout during a purchase transaction; (b) making, receiving, and storing a visual record by means of a camera positioned to capture a visual image of goods corresponding with the cash register transaction readout; (c) processing and transferring the cash register transaction readout and visual image of goods corresponding with the cash register transaction readout to a remote location; (d) displaying the cash register transaction readout and visual image of goods corresponding with the cash register transaction readout on a screen as adjacent images.

The method further comprises comparing the cash register readout with the visual record to determine discrepancies between items paid for and items leaving the store with customers; and selectively recalling stored data and stored records for evidence of discrepancies.

Stated in alternative terms, the invention is characterized as a method of providing point of sale (POS) surveillance comprising the steps of: generating a cash register electronic report of a sales transaction; generating a visual image of goods which are subject to the sales transaction; correlating the visual image of goods and electronic report with each other in a record; and comparing the electronic report with a visual record of items purchased in the record to determine any discrepancy between goods actually sold and those reported in the electronic report.

The method in one embodiment further comprises the step of maintaining an inventory of goods based on the electronic reports being corrected according to the discrepancy between goods actually sold and those reported in the electronic report.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a schematic depiction showing the instant invention.

FIG. 2 is an exemplary front plan view of a monitor and a typical display on a security officer's screen.

FIGS. 3a to 3c are exemplary plane views of a variety of kits of the instant invention.

FIG. 3d is a schematic showing several of a variety of kits together as a package.

FIG. 4 is an exemplary depiction showing placement of plural cameras.

FIG. 5 is an exemplary display showing plural visual records per cash register readout.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

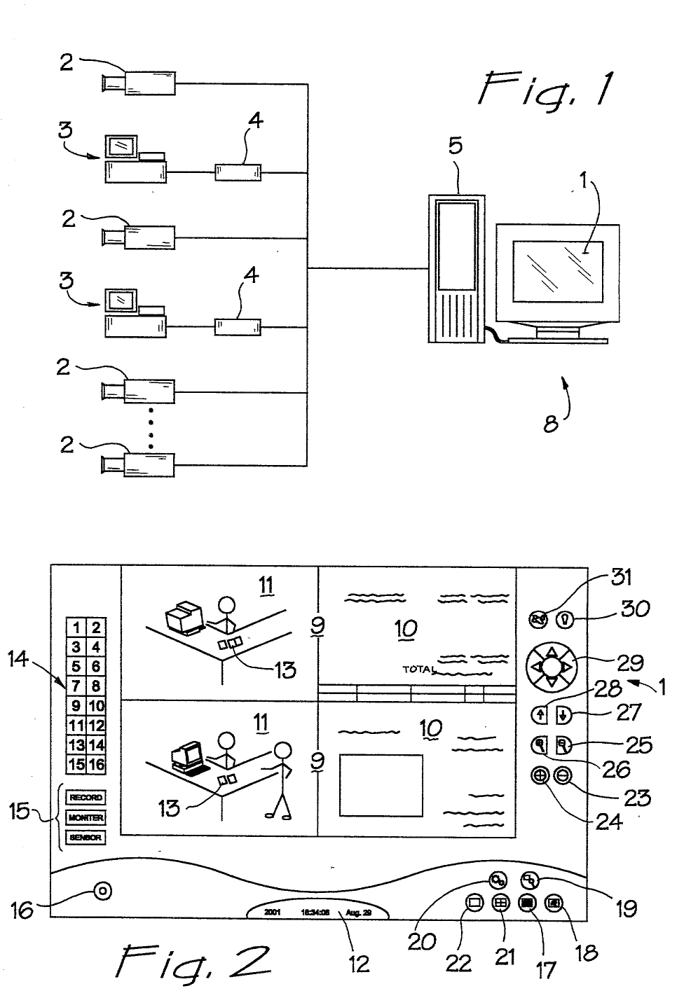

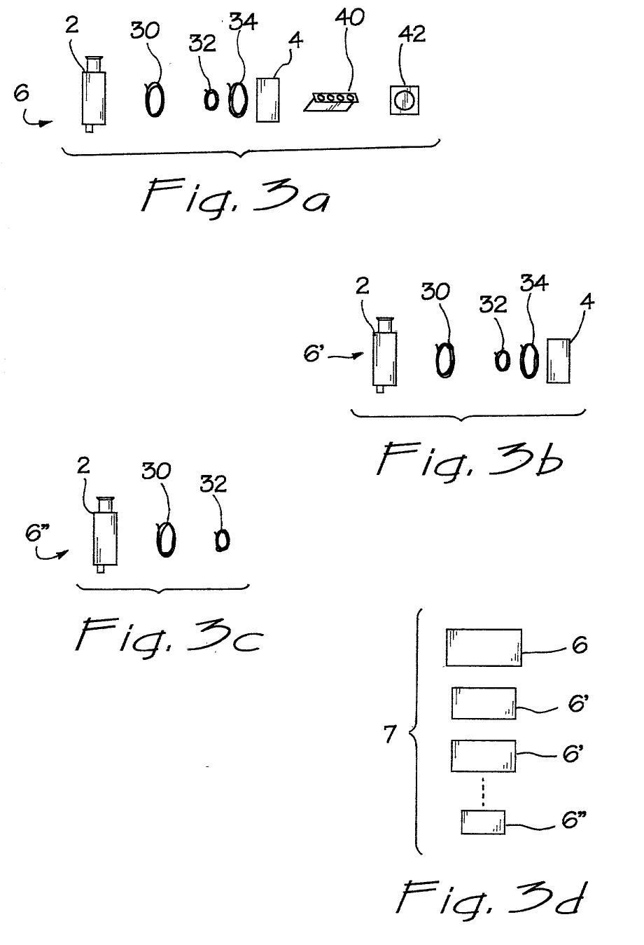

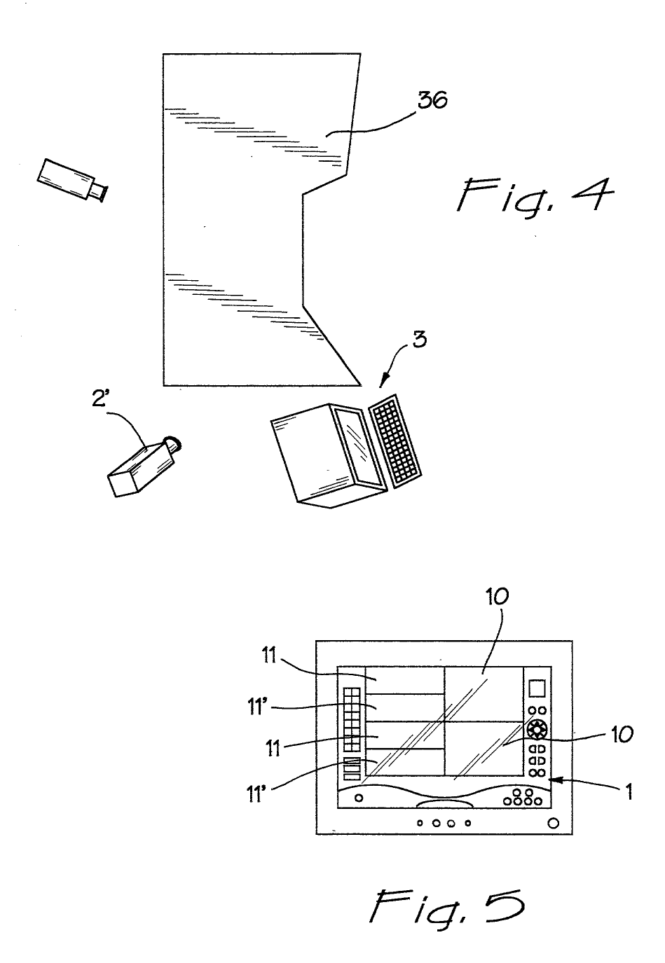

FIGS. 1 and 2 show a point of sale (POS) surveillance system 8 that has the ability to show side-by-side pictures 9 of the cash register readout 10 and a visual record 11 of the physical transaction, including the items purchased 13. The invention employs picture in picture (PIP) technology for side-by-side register readout 10 and visual record pictures 11, and for multiple side-by-side pairs of such pictures that can be displayed on a single screen as indicated by the multi-picture screen button 12. This permits a security officer to view several points of sale simultaneously.

FIG. 2 shows the security officer's monitor display 1. A number of camera keys 14 greater than or equal to the number cameras to be used may be activated in any conventional way including by mouse clicking. Each POS is monitored by at least one camera. Indicators 15 below the camera keys are lighted to indicate the mode of operation of the system. An on/off switch 16 is located at the lower left corner of the monitor 1. The monitor includes a digital time and date readout 12. Several function keys 17, 18, 19, 20, 21, 22 are located at the lower right side of the monitor to select the display mode. Buttons 23, 24, 25, 26, 27, 28, 30, 31 are for moving, orienting, re-sizing, and otherwise manipulating the pictures on the screen.

All of the buttons and keys may be activated in any conventional way including by mouse clicking. While the keys and buttons have been described in a particular configuration on the monitor display, it should be understood that the keys and buttons may be disposed in any convenient configuration. Many such configurations are provided by DVR (digital video recording) software. Alternatively, the monitor display may be replaced by hardware with hard function keys.

FIG. 2 best illustrates one of the prime benefits of the POS surveillance system 8. As can be seen in the side-by-side pictures 9 showing the visual record 11 and the cash register readout 10, the number of items paid for can easily be counted and compared with the number of actual pieces of merchandise at the counter for purchase. Upon discovering a discrepancy, the user can further examine the merchandise to see which items were not paid for. The visual record can also be used to confirm the identity of the cashier responsible for the error and to identify the customer making the purchase. The visual record thus makes significant advances over the prior art.

The first embodiment of the present invention includes one camera 2 inputting one visual record 11 per transaction. Other embodiments include plural visual records 11, 11′ per transaction, several cameras 2, 2′ per POS, and kits 6, 6′, 6″ for installing the surveillance system in new or existing register/inventory systems.

For all of the embodiments, making and storing a permanent record is a key feature of the present invention. This permanent record comprises the cash register readout 10 and the corresponding visual record(s) 11 for each transaction. The readout 10 and the visual record 11 are correlated for adjacent screen viewing and easy recall.

A method of using the surveillance system involves:

(a) placing a camera 2 or cameras 2,2′ in a manner to capture the needed visual record(s) 11 of the transaction and items 13 apparently sold;

(b) receiving the visual record and the cash register readout in side-by-side format on a remote screen; and

(c) comparing the visual record 11 with the cash register readout 10.

If the visual record 11 and the register readout 10 do not match, the data can be used to provide evidence of a colluding cashier and customer.

It is also contemplated that each of the embodiments would include a means for keeping track of inventory.

FIGS. 3a to 3c show kits 6, 6′, 6″ for installation of the POS surveillance system. FIG. 3d depicts an exemplary package for stores having multiple points of sale. Several kits may be combined to provide a package 7 of any number and variety of kits including, but not limited to those shown in FIGS. 3a to 3c.

As shown in FIG. 3a, it is contemplated that a base kit will comprise at least one camera per POS, an output cable for each camera output adapted for connection to a processor 5, an output cable for each cash register to be used, at least one video graphics array (VGA) to TV device per POS, an output cable for each VGA-to-TV conversion device 4 adapted for connection to the processor 5, an input port unit 40 for connecting the output cables from the camera 2 and VGA-to-TV conversion device 4 to the processor 5, and software 42 adapted for use with the processor 5. Other kits 6, 6′, 6″ may be included with a base kit 6 to form a package 7. Every kit in a package does not need all the components of the base kit 6. For example, cables of a kit 6′ may occupy some of the ports of port unit 40 of a kit 6.

The cables 32, 34 from the cameras 2 and the conversion devices 4 are connected to an input port of the port unit 40, which is associated with the processor. The input port unit 40 may be installed in the processor. The input port unit 40 can include a plurality of ports and more than one input port unit 40 may be installed in the processor. At present the input port units 40 are integral with a DVR (digital video recording) board. In use, each input port unit 40 can support a maximum number of kits equal to one half the number of ports in the input port unit 40. This is because each kit needs at least one input port for the camera output and one input port for the VGA-to-TV output to the processor. It can be seen that with more cameras 2 in a kit, more input ports on the processor will be occupied.

FIG. 3c shows a kit 6″ without the VGA-to-TV conversion device. This kit 6″ is used with a processor having an internal VGA-to-TV conversion device. As such, Kit 6″ may or may not need an input port unit 40.

The software 42 includes programming to integrate the input data from each camera and VGA-to-TV device with DVR (Digital Video Recording) software. The DVR software provides a simulated monitor display with soft buttons and keys that can be activated on the screen. The software 42 thus integrates the input data from each camera and VGA-to-TV device with the DVR system. The DVR software in turn processes, correlates, and creates a permanent record from the data. The DVR software further comprises PIP capability and programming for recalling the data from the permanent record. Thus, data from each cash register and camera output from each POS can be displayed at any time in visual format on a screen.

FIG. 4 depicts a POS having a plurality of selectively located cameras 2, 2′. Cameras may be placed at almost any location including directly above the cash register table. The cameras 2, 2′ may be hidden or openly visible to the cashier or customers. Knowledge of the POS surveillance system at a given POS can effectively deter cashiers and customers from collusive efforts at that POS.

FIG. 5 illustrates how two or more visual records 11, 11′ can be displayed for each cash register readout 10. Alternatively, plural visual records can be sequentially displayed while a corresponding single cash register readout 10 is displayed. The plural visual records 11, 11′ may be from a single camera 2 or from plural cameras 2, 2′. A further alternative is a motion type picture for the visual record(s) 11, 11′. Such a motion type picture can be obtained by a video camera.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

I claim:

1. A point of sale (POS) surveillance system for comparing a cash register readout with a visual record of items purchased comprising:
a cash register which produces an electronic report of a sales transaction;
a camera which makes a visual image of goods which are subject to said sales transaction; and
a processor coupled to said camera and cash register, which processor creates a record in which said visual image of goods and electronic report are correlated with each other.

2. The POS surveillance system of claim 1 further comprising at least one digital recorder for storing said record of said correlated visual image of goods and electronic report.

3. The POS surveillance system of claim 2 wherein said digital recorder stores a multiplicity of correlated visual images of goods and electronic reports corresponding to a corresponding multiplicity of sales transactions.

4. The POS surveillance system of claim 1 wherein said report from said cash register is in a video graphics array (VGA) format and further comprising a conversion device to convert said electronic report to a television compatible format.

5. The POS surveillance system of claim 1 further comprising a multi-picture display device in which said correlated visual image of goods and electronic report are displayed.

6. The POS surveillance system of claim 5 where said multi-picture display device comprises a picture in picture (PIP) output displaying said electronic report adjacent to said visual image.

7. The POS surveillance system of claim 1 comprising at least one additional camera.

8. The POS surveillance system of claim 1 comprising at least one additional cash register.

9. The POS surveillance system of claim 1 comprising a plurality of cash registers, a plurality of cameras, and wherein said processor simultaneously displays electronic reports from said plurality of cash registers and corresponding visual images of goods from said plurality of cameras, whereby a security agent at a remote location may simultaneously view in real time a corresponding plurality of sales transactions with corresponding visual records from a plurality of distinct points of sale.

10. The POS surveillance system of claim 1 further comprising means for creating a permanent record of said electronic report and said corresponding visual image of said goods correlated to said sales transaction.

11. The POS surveillance system of claim 1 further comprising an automatic inventory record system for keeping track of merchandise remaining in stock.

12. A point of sale (POS) surveillance system kit for use with a computer and a cash register with VGA readout comprising:
a camera with visual readout;
a VGA-to-TV conversion device;
a cable for cash register readout adapted for connection to the conversion device;
a cable for camera output adapted for connection to the computer;
a cable for output of the conversion device and adapted for connection to the computer, and
wherein said computer is arranged and configured under software control to create a permanent record of the cash register readout and a corresponding said visual record for easy recall, said software also comprising picture in picture (PIP) capability and programming for processing the cash register and camera visual readout and for graphically displaying correlated images of said cash register readout and camera visual readout.

13. The POS surveillance system kit of claim 12 wherein said computer is further arranged and configured by software control to include an automatic inventory recording system for keeping track of merchandise remaining in stock.

14. A point of sale (POS) surveillance system kit for a plurality of points of sale (POS), a corresponding plurality of cash registers with readout for use with a computer comprising:
(a) at least one camera per POS with a camera output,
(b) at least one VGA-to-TV conversion device per POS,
(c) a cable for each cash register readout to a respective said conversion device,
(d) a cable for each camera output adapted for connection to the computer,
(e) a cable for each output of a respective conversion device and adapted for connection to the computer, and
(f) wherein the computer is arranged and configured by software control to create a permanent record of each said cash register readout and a corresponding said visual record of goods which were sold at the POS corresponding to said cash register readout, said software further providing picture in picture (PIP) capability and programming for processing cash register readout and camera output from each POS and for displaying the cash register readout and camera output in a correlated visual format on a screen.

15. The POS surveillance system kit of claim 14 wherein the software also comprises an automatic inventory recording system for keeping track of merchandise remaining in stock.

16. A method providing point of sale (POS) surveillance comprising:
(a) receiving and storing data from a cash register transaction readout during a purchase transaction;
(b) making, receiving, and storing a visual record by means of a camera positioned to capture a visual image of goods corresponding with the cash register transaction readout;
(c) processing and transferring the cash register transaction readout and visual image of goods corresponding with the cash register transaction readout to a remote location;
(d) displaying the cash register transaction readout and visual image of goods corresponding with the cash register transaction readout on a screen as adjacent images.

17. The method of claim 16 further comprising:
comparing the cash register readout with the visual record to determine discrepancies between items paid for and items leaving the store with customers; and
selectively recalling stored data and stored records for evidence of discrepancies.

18. A method of providing point of sale (POS) surveillance comprising the steps of:
generating a cash register electronic report of a sales transaction;
generating a visual image of goods which are subject to said sales transaction;
correlating said visual image of goods and electronic report with each other in a record; and
comparing said electronic report with a visual record of items purchased in said record to determine any discrepancy between goods actually sold and those reported in said electronic report.

19. The method of claim 18 further comprising the step of maintaining an inventory of goods based on said electronic reports in accordance with corrected said discrepancy between goods actually sold and those reported in said electronic report.

20. The POS surveillance system kit of claim 14 further comprising at least one input port unit for connection with the output cables of the at least one camera and the at least on conversion device.
